(19) United States
(12) Patent Application Publication
(10) Pub. No.: US 2006/0271943 A1
(43) Pub. Date: Nov. 30, 2006

(54) Recording and reproducing unit and information recording and reproducing device incorporating recording and reproducing unit

(75) Inventor: Masahiko Nishide, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/440,067

(22) Filed: May 25, 2006

(30) Foreign Application Priority Data
May 31, 2005 (JP) 2005-160440

(51) Int. Cl. G11B 17/04; G11B 33/02

(52) U.S. Cl. 720/602; 720/645

(57) ABSTRACT

It is an object of the present invention to realize detection of a disk loading/ejection position where a disk which is a storage medium can be changed and a recording/reproducing position inside an information recording and reproducing device using an existing configuration member and thereby control the driving of a tray on which a disk is placed. A joint having an inclined plane which is irradiated with laser light irradiated from a pickup unit is formed and the laser light from the pickup unit is irradiated when the tray moves. When the tray moves between the disk loading/ejection position and the recording/reproducing position, it is detected that the laser light irradiated from pickup unit is irradiated onto the inclined plane and shielded and a motor is driven only for a preset time relative to the detected position.

The present application is based on and claims priority of Japanese patent application No. 2005-160440 filed on May 31, 2005, the entire contents of which are hereby incorporated by reference.

### BACKGROUND OF THE INVENTION

1. Field of the Invention

The present invention relates to an information recording and reproducing device which incorporates a recording and reproducing unit provided with a tray which moves with a storage medium placed thereon, and more particularly, to a type of recording and reproducing unit and information recording and reproducing device which incorporates such a recording and reproducing unit whose tray moves to the outside of the information recording and reproducing device to allow a storage medium to be changed, using a pickup unit as tray position detection means.

Detection of the position of the tray to be detected in this case includes detecting that the tray has reached a disk loading/ejection position, detecting that the tray has moved into the information recording and reproducing device and reached a recording and reproducing position at which recording/reproducing onto/from a storage medium is allowed or detecting that the tray at the disk loading/ejection position has been manually pushed into the information recording and reproducing device or the like.

The term “Recording/reproducing” of information in the present specification is used to represent recording or/and reproducing information.

2. Description of the Related Art

Examples of a generally called “front loading” type of information recording and reproducing device which incorporates a recording and reproducing unit (hereinafter, also simply referred to as “unit”) provided with a tray which moves back and forth with respect to the device include an information recording and reproducing device which performs records/reproduces information using a disk-shaped storage medium (hereinafter, simply referred to as “disk”). Here, general operation of a device provided with a tray which moves back and forth will be explained. First, pushing a tray opening and closing button, which is one of operation buttons arranged on the front of the information recording and reproducing device causes a motor which becomes a transfer drive source to start to operate and move the tray stored inside the information recording and reproducing device to a position (hereinafter, referred to as “disk loading/ejection position”) where it is possible to load or change a disk outside the information recording and reproducing device through a drive transmission mechanism. The motor stops when the tray reaches the disk loading/ejection position and the disk is placed on the loading surface on the top surface of the tray or the disk is changed. Here, pushing the tray by hand or pressing the opening and closing button of the information recording and reproducing device causes the motor which has been stopped to start rotating in the opposite direction and the tray carrying the disk starts to move toward the inside of the information recording and reproducing device. The motor stops when the tray reaches the position at which recording/reproducing data into/from the disk is allowed (hereinafter, referred to as “recording/reproducing position”), the disk placed on the top surface of the tray is lifted by a turntable from below and held between this turntable and a clamper which is located facing the turntable. Inside the recording and reproducing unit is a pickup unit which irradiates laser light to write and record information onto the disk or read and reproduce information recorded in the disk before hand, and pressing the record button or playback button out of the buttons arranged on the front of the information recording and reproducing device or a remote controller to operate the information recording and reproducing device causes the turntable which holds the disk to start rotating and causes a pickup unit which moves in a direction perpendicular to the disk turning direction to irradiate laser light and start writing information onto the recording surface of the disk or reading information from the recording surface of the disk.

When the tray moves from the inside of the information recording and reproducing device and reaches the disk loading/ejection position or the tray moves from the outside of the information recording and reproducing device and reaches the recording/reproducing position, detection means is necessary to stop the operation of the motor. Moreover, when the tray at the disk loading/ejection position is pushed by hand to start moving, detection means is necessary to start the stopped motor and a limit switch is conventionally used as such general detection means.

Japanese Patent Laid-Open Publication No. 2003-217212 (Patent document 1) discloses a structure in a simple configuration capable of detecting to which of the disk loading/ejection position or the recording/reproducing position the tray has moved. That is, a single tray position detection switch is disposed in the vicinity of an inlet/outlet of a frame and the tray is provided with a large protrusion for a trigger and a small protrusion for a trigger for a tray position detection switch to detect when the tray has reached the disk loading/ejection position or the recording/reproducing position. The structure is designed so as to judge the tray stop position from a distinction between ON and OFF of the tray position detection switch and control rotation of the motor to transport the tray in the direction opposite the stop position to thereby enable the position of the tray to be detected accurately.

However, according to the structure described in Patent document 1, a switch is also necessary to detect to which of the disk loading/ejection position or the recording/reproducing position the tray has moved, which may cause an increase in the cost of the unit or increase in the number of man-hours for assembly work. It is also necessary to provide a space for disposing the switch in the frame of the unit and further, the large protrusion for a trigger and the small protrusion for a trigger for pressing the switch are formed in the tray, and therefore this structure is unsuitable for downsizing of the unit.

### SUMMARY OF THE INVENTION

It is an object of the recording and reproducing unit and information recording and reproducing device which incorporates the recording and reproducing unit of the present invention to solve the above described problems and provide a recording and reproducing unit and an information recording and reproducing device which incorporates such a recording and reproducing unit capable of realizing tray position detection using an optical pickup unit which is an existing element necessary to compose a recording and reproducing unit and downsizing the recording and reproducing unit.

The recording and reproducing unit according to a first aspect of the present invention is a recording and reproducing unit comprising a tray on which a storage medium is placed, a frame which supports the tray such that the tray can freely make a reciprocating motion, a pickup unit built in the frame which writes information onto the storage medium or reads information from the storage medium and drive means for moving the tray from the outside of the frame where the storage medium can be changed to the inside of the frame where the storage medium faces the pickup unit, wherein the position of the storage medium on the tray is detected by using laser light irradiated from the pickup unit to detect whether the storage medium is transferred to a recording/reproducing position facing the pickup unit or not or whether the storage medium is transferred to a disk loading/ejection position outside the frame or not and wherein the drive means is controlled based on a detection signal of the pickup unit.

According to the first aspect of the present invention, it is detected using laser light irradiated from the pickup unit whether the storage medium is transferred to a recording/reproducing position facing the pickup unit or not or whether the storage medium is transferred to a disk loading/ejection position outside the frame or not and the drive means is started/stopped through the control means, and therefore it is possible to eliminate the conventionally required tray position detection switch and omit the space for mounting the switch in the frame of the unit.

The information recording and reproducing device incorporating a recording and reproducing unit according to a second aspect of the present invention is an information recording and reproducing device incorporating a recording and reproducing unit and control means for controlling the drive means of the recording and reproducing unit, the recording and reproducing unit comprising a tray on which a storage medium is placed drive means for driving the tray, and a pickup unit which writes information onto the storage medium or reads information from the storage medium, wherein the drive means is controlled through the control means based on a detection signal from the pickup unit by using laser light irradiated from the pickup unit to detect whether the storage medium is transferred to a recording/reproducing position facing the pickup unit or not or whether the storage medium is transferred to a disk loading/ejection position outside the frame or not.

According to the second aspect of the present invention, it is detected using laser light irradiated from the pickup unit whether the tray which is enabled by the drive means to make a reciprocating motion between the inside of the information recording and reproducing device and the outside of the information recording and reproducing device is transferred to the disk loading/ejection position outside the information recording and reproducing device or to the recording/reproducing position outside the information recording and reproducing device and the drive means is started/stopped through the control means, and therefore it is possible to eliminate the conventionally required tray position detection switch and omit the space for mounting the switch in the frame of the unit.

The information recording and reproducing device which incorporates a recording and reproducing unit according to a third aspect of the present invention is the information recording and reproducing device which incorporates a recording and reproducing unit according to the second aspect of the present invention, wherein upon detecting by means of laser light irradiated from the pickup unit that the tray has been manually pushed from the disk loading/ejection position where the storage medium can be changed to the inside of the information recording and reproducing device, the drive means is controlled through the control means based on a detection signal by the laser light.

According to the third aspect of the present invention, a variation of the position of the tray which moves when the user pushes the front-end part of the tray at the disk loading/ejection position is detected using laser light irradiated from the pickup unit and the drive means is started through the control means, and therefore it is possible to eliminate the conventionally required tray position detection switch and omit the space for mounting the switch in the frame of the unit.

The information recording and reproducing device which incorporates a recording and reproducing unit according to a fourth aspect of the present invention is the information recording and reproducing device which incorporates a recording and reproducing unit according to the second or third aspect of the present invention, wherein the tray is provided with an opening for allowing laser light irradiated from the pickup unit to impinge on the recording surface of the storage medium and a joint behind the opening and wherein the tray drive means is controlled in response to detecting that the joint is irradiated with the laser light irradiated from the pickup unit.

According to the fourth aspect of the present invention, it is detected from the light-receiving section of the pickup unit that the joint formed at the back of the moving tray is irradiated with laser light irradiated from the light-emitting section of the pickup unit and the drive means is started/stopped through the control means, and therefore it is possible to eliminate the conventionally required tray position detection switch and omit the space for mounting the switch in the frame of the unit.

The information recording and reproducing device which incorporates a recording and reproducing unit according to a fifth aspect of the present invention is the information recording and reproducing device which incorporates a recording and reproducing unit according to any one of the second to fourth aspects of the present invention, wherein the position of the moving tray is detected from a change in the voltage value when the laser light irradiated from the pickup unit is reflected and the reflected laser light is received by the pickup unit.

According to the fifth aspect of the present invention, driving or stoppage of the drive means is controlled through the control means based on a variation of the detection voltage when the laser light irradiated from the pickup unit is reflected and reenters the pickup unit, and therefore it is possible to detect the position of the tray by the pickup unit from which the laser light is irradiated.

The information recording and reproducing device which incorporates a recording and reproducing unit according to a sixth aspect of the present invention is the information recording and reproducing device which incorporates a recording and reproducing unit according to the fourth or fifth aspect of the present invention, wherein the joint of the tray is provided with an inclined plane as the plane facing the pickup unit.

According to the sixth aspect of the present invention, it is detected that laser light irradiated from the pickup unit is irradiated onto the inclined plane formed on the joint of the moving tray and shielded and startup or stoppage of the drive means is controlled through the control means, and therefore it is possible to detect the position of the moving tray by clarifying the difference from laser light reflected on parts other than the incline plane.

The information recording and reproducing device which incorporates a recording and reproducing unit according to a seventh aspect of the present invention is the information recording and reproducing device which incorporates a recording and reproducing unit according to any one of the fourth to sixth aspects of the present invention, wherein the laser light irradiated from the pickup unit reflected on the joint of the tray is detected, and the drive means is controlled by presetting the time for the tray to reach the disk loading/ejection position from inside the information recording and reproducing device or the time for the tray to reach the recording/reproducing position from outside the information recording and reproducing device.

According to the seventh aspect of the present invention, by presetting the time after laser light is irradiated onto the joint until the tray reaches the disk loading/ejection position when the tray moves from the inside of the information recording and reproducing device to the outside of the information recording and reproducing device relative to the position where the joint of the tray moving between the disk loading/ejection position and the recording/reproducing position is irradiated with laser light irradiated from the pickup unit, or on the contrary, the time after the laser light is irradiated onto the joint until the tray reaches the recording/reproducing position when the tray moves from the outside of the information recording and reproducing device to the inside of the information recording and reproducing device, driving the control means for only the time after the laser light irradiated from the pickup unit is irradiated onto the joint until the tray reaches the disk loading/ejection position or the time after the laser light irradiated from the pickup unit is irradiated onto the joint until the tray reaches the recording/reproducing position and performing control using the control means so that the drive means is stopped when the set time is passed, and therefore it is possible to stop the moving tray at the disk loading/ejection position or the recording/reproducing position without using the conventionally required tray position detection switch.

The information recording and reproducing device which incorporates a recording and reproducing unit according to an eighth aspect of the present invention is the information recording and reproducing device which incorporates a recording and reproducing unit according to any one of the second to seventh aspects of the present invention, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position.

According to the eighth aspect of the present invention, in conjunction with the moving operation of the tray when making a reciprocating motion between the disk loading/ejection position and the recording/reproducing position, the chassis to which the pickup unit is attached pivots on the one end of the chassis connected to the frame of the recording and reproducing unit as a supporting point so as to be placed in an inclined position when the tray is at the disk loading/ejection position outside the information recording and reproducing device and in a horizontal position when the tray is at the recording/reproducing position, and further the inclined plane of the joint formed at the back of the tray is provided so as to be substantially parallel to the chassis in the inclined position, and therefore it is possible to more accurately detect that laser light irradiated from the pickup unit is irradiated onto the inclined plane formed on the joint of the moving tray and control the startup or stoppage of the moving tray.

### BRIEF DESCRIPTION OF THE DRAWINGS

FIG. 1 is a perspective view showing the appearance of an information recording and reproducing device which incorporates a recording and reproducing unit as an embodiment of the present invention;

FIG. 2 is a plan view showing the whole shape of the recording and reproducing unit according to the above embodiment of the present invention;

FIG. 3 is a plan view showing the recording and reproducing unit according to the above embodiment of the present invention when the tray is removed;

FIG. 4 shows the shape of the tray as a single unit according to the above embodiment of the present invention; FIG. 4(a) is a plan view, FIG. 4(b) is a side view and FIG. 4(c) is a bottom view;

FIG. 5 shows side sectional views of the recording and reproducing unit according to the above embodiment of the present invention; FIG. 5(a) is a side sectional view showing that the tray is at a disk loading/ejection position, FIG. 5(b) is a side sectional view showing that the tray is at a recording/reproducing position;

FIG. 6 is a flow chart showing control processing when the tray at the disk loading/ejection position outside the information recording and reproducing device is moved to the recording/reproducing position inside the information recording and reproducing device by pressing the tray opening and closing button;

FIG. 7 is a flow chart showing control processing when the tray at the disk loading/ejection position outside the information recording and reproducing device is moved to the recording/reproducing position inside the information recording and reproducing device by the user's pushing a front-end part of the tray to thereby start the motor; and

FIG. 8 is a flow chart showing control processing when the tray at the recording and reproducing position inside the information recording and reproducing device is moved to the disk loading/ejection position outside the information recording and reproducing device by pressing the tray opening and closing button.

### DETAILED DESCRIPTION OF THE PREFERRED EMBODIMENTS

Hereinafter, as the best mode for implementing the present invention, embodiments of the present invention will be explained with reference to attached drawings.

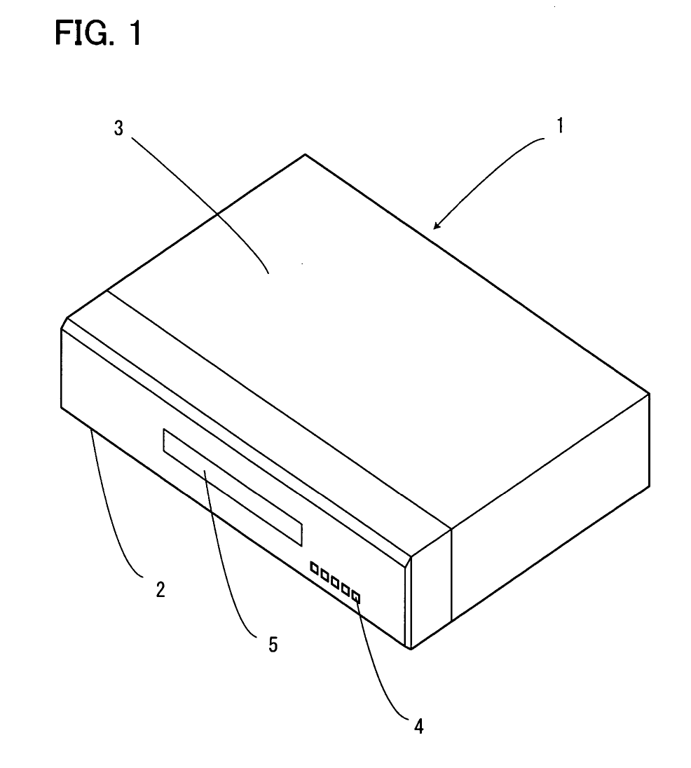

FIG. 1 is a perspective view showing the outside shape of an embodiment of an information recording and reproducing device which incorporates a recording and reproducing unit (not shown in FIG. 1) for recording and reproducing data onto/from a disk which is a storage medium of the present invention.

An information recording and reproducing device 1 is provided with an operation section 4 which made up of a plurality of operation buttons on the front side and a front panel 2 provided with a through hole 5 which allows movement of a tray, and a top plate 3 which covers the top surface and both sides and a chassis (not shown) which corresponds to the bottom side and back side behind the front side, these front panel 2, top plate 3 and chassis constituting the appearance of the apparatus.

The information recording and reproducing device 1 incorporates a recording and reproducing unit 10 provided with a tray and a plurality of electronic parts including a substrate to perform various types of control for the information recording and reproducing device 1. Furthermore, the through hole 5 is formed on the transfer orbit, which allows the tray for carrying a disk to make a reciprocating motion, and after a disk is placed on the tray which is in a position pulled out of the information recording and reproducing device 1, that is, the tray at the disk loading/ejection position, if the user presses a tray opening and closing button which is one of the operation buttons 4 provided on the front panel 2 or the user slightly pushes a front-end part of the tray, the tray starts to move into the information recording and reproducing device 1 through the through hole 5 formed in the front panel 2.

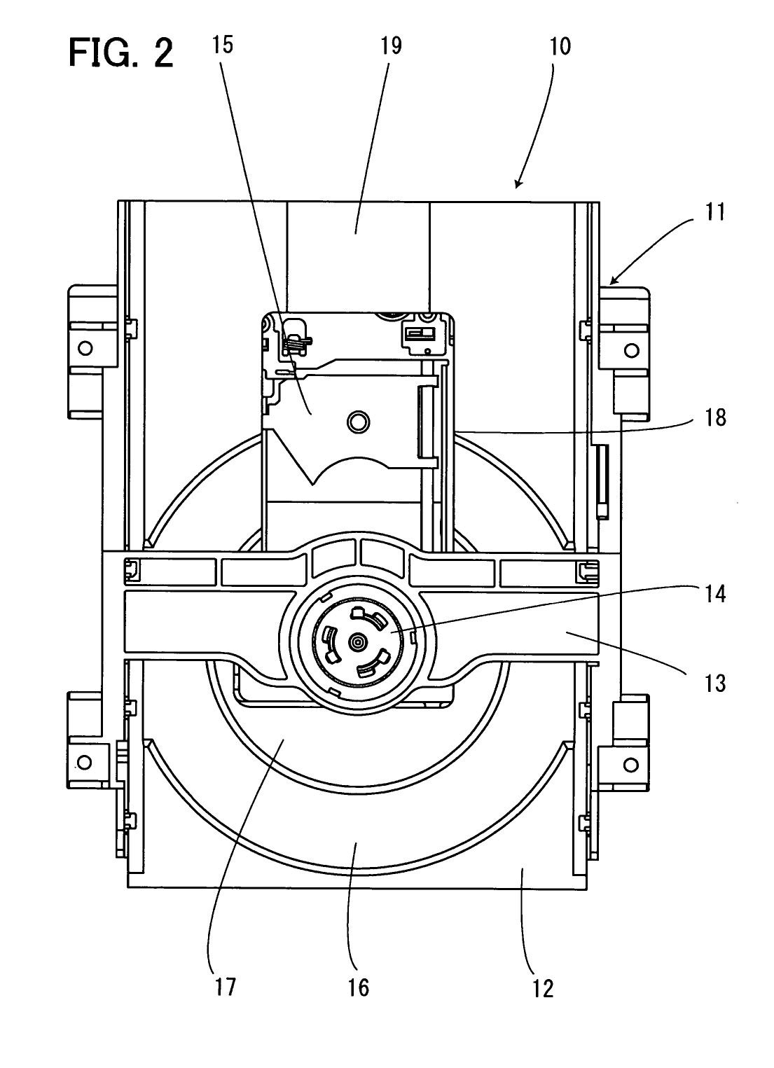

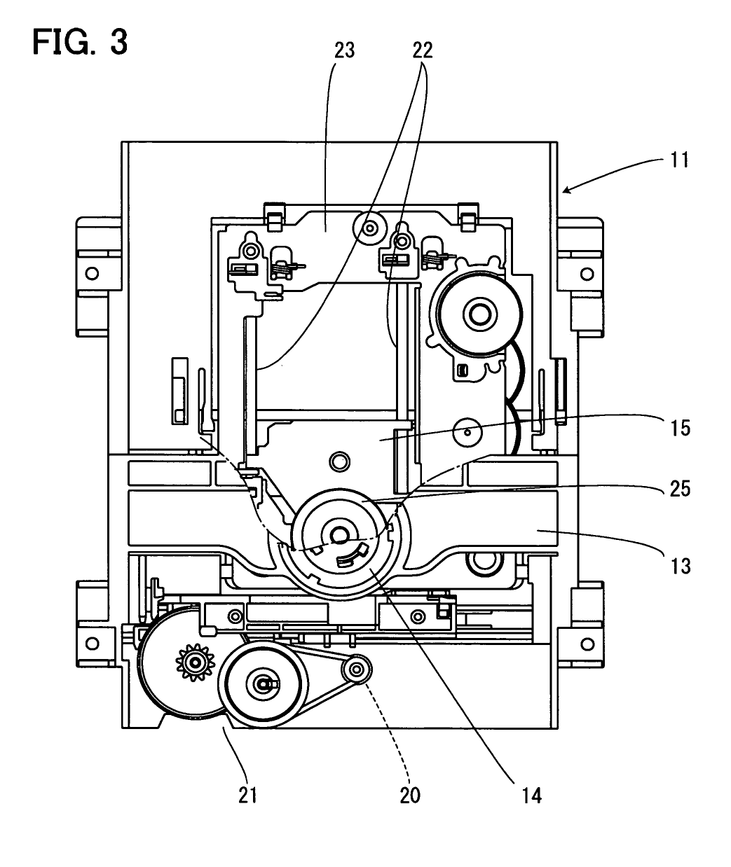

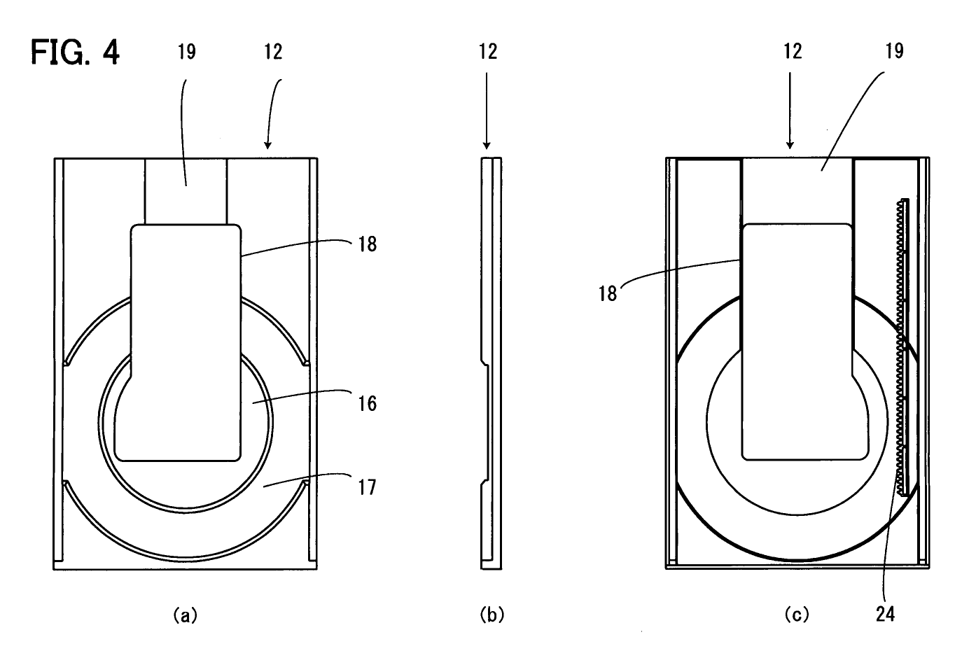

Next, the structure of the recording and reproducing unit 10 which is incorporated in the information recording and reproducing device 1 will be explained with reference to FIGS. 2 to 4. FIG. 2 is a plan view showing the whole shape of the recording and reproducing unit, FIG. 3 is a plan view showing the recording and reproducing unit when the tray is removed and FIG. 4 shows the shape of the tray as a single unit; FIG. 4(a) showing a plan view and FIG. 4(b) showing a side view and FIG. 4(c) showing a bottom view.

A tray 12 which moves with a disk placed thereon is built in a frame 11 of the recording and reproducing unit 10 and this tray 12 can make a reciprocating motion for a direct distance between a recording/reproducing position inside the information recording and reproducing device 1 where recording or reproduction of a disk is possible and a disk loading/ejection position outside the information recording and reproducing device 1 where the disk can be changed. That is, a rack gear 24 is formed on the bottom face of the tray 12 allowing the tray 12 to make a reciprocating motion between the recording/reproducing position inside the information recording and reproducing device 1 and the disk loading/ejection position outside the information recording and reproducing device 1 by transmitting a rotating/driving force of a motor 20 attached to the frame 11 to the rack gear 24 of the tray 12 through a drive transmission mechanism 21 made up of a plurality of gear groups and a pulley.

Furthermore, a pickup unit 15 which writes and records information on the recording surface of the disk or reads and reproduces information from the recording surface of the disk is built in the frame 11, attached to a chassis 23 through guide members 22 which regulate the moving direction thereof. The chassis 23 is provided with a turntable 25 which turns while lifting the disk on the tray 12 carried into the information recording and reproducing device 1, a support section 13 which extends horizontally in the width direction of the recording and reproducing unit 10 is provided at the top of the frame 11 facing the turntable 25 and this support section 13 is provided with a damper 14 which holds the disk together with the turntable 25. Therefore, the disk which has moved from the outside of the information recording and reproducing device 1 to the inside of the information recording and reproducing device 1 together with the tray 12 is slightly lifted from the tray 12 by the turntable 25 which is attached to the chassis 23 at the recording/reproducing position, turned while being held between the turntable 25 and the damper 14 which is located at a position facing the turntable, and the pickup unit 15 moves between the inner radius and the outer radius of the disk along the guide members 22 perpendicular to the rotation direction of the disk, allowing information to be recorded onto the disk or information recorded on the disk to be reproduced through laser light irradiated from the pickup unit 15.

A large diameter disk mounting recessed part 16 for placing a large diameter disk is formed on the top surface of the tray 12 in such a way as to be slightly lower than the top surface of the tray 12 and a small diameter disk mounting recessed part 17 for placing a small diameter disk is formed in such a way as to be slightly lower than the large diameter disk mounting recessed part 16. An opening 18 which is formed by cutting out part of the large diameter disk mounting recessed part 16 and small diameter disk mounting recessed part 17 is formed in substantially the center of the tray 12. This opening 18 is provided to irradiate the recording surface of the disk with laser light irradiated from the pickup unit 15 to write and record information on the recording surface of the disk or read and reproduce information from the recording surface of the disk.

Furthermore, the chassis 23 to which the pickup unit 15 and the turntable 25 are attached is connected through a buffering member 26 at the back of the frame 11 of the recording and reproducing unit 10, which allows the chassis 23 to pivot between a horizontal position and an inclined position according to the reciprocating motion of the tray. That is, when the tray 12 is at the disk loading/ejection position outside the information recording and reproducing device 1, the chassis 23 is in an inclined position with respect to the rear part at which the chassis 23 is connected to the frame 11 of the recording and reproducing unit 10 as a supporting point to prevent the turntable 25 or the like attached to the chassis 23 from blocking the movement of the tray 12. After the tray 12 at the disk loading/ejection position moves into the information recording and reproducing device 1 and reaches the recording/reproducing position, the chassis 23 in the inclined position pivots around the joint with the frame 11 as a supporting point and is placed in a horizontal position.

A joint 19 is integrally molded with the tray 12 behind the opening 18 which is formed in the tray 12. This joint 19 has a dual function of compensating for the strength of the tray 12 which has reduced due to the formation of the opening 18 and at the same time detecting a tray passage position with the laser light which is irradiated from the pickup unit 15, reflected on the bottom surface (bottom side of the tray 12) of the joint 19 and reentering the pickup unit. For this purpose, an inclined plane 27 which is substantially parallel to the chassis 23 which is inclined with respect to the rear part connected to the frame 11 of the recording and reproducing unit 10 as a supporting point is formed on the bottom face of the joint 19 so that when the inclined plane 27 of the joint 19 is irradiated with laser light, the laser light is easily reflected back toward the pickup unit.

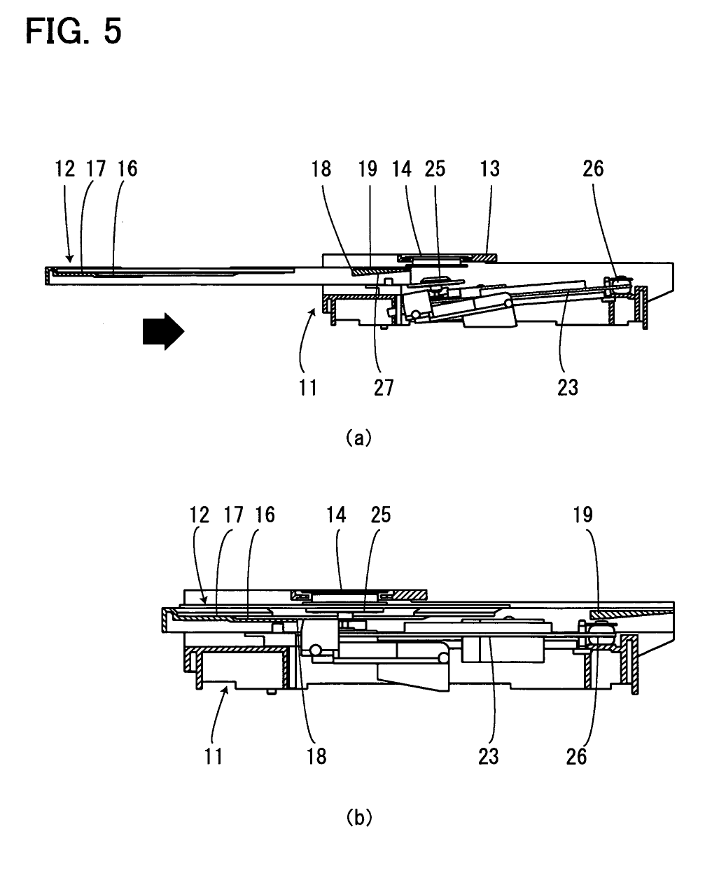

Here, the operation of the disk device will be explained in detail. FIG. 5 shows a side sectional view of the disk device; FIG. 5(a) showing the tray located at the disk loading/ejection position outside the information recording and reproducing device and FIG. 5(b) showing the tray located at the recording/reproducing position inside the information recording and reproducing device, respectively

First, the operation when the tray 12 at the disk loading/ejection position moves to the inside of the information recording and reproducing device 1 will be explained. As shown in FIG. 5(a), when the tray 12 is at the disk loading/ejection position, the chassis 23 is inclined with respect to the joint connected at the back of the frame 11 of the recording and reproducing unit 10 through buffering member 26 as a supporting point. Laser light is irradiated from the pickup unit 15 attached to the chassis 23 and when a disk is placed on the top surface of the tray 12 at the disk loading/ejection position and the user pushes the front-end part of the tray 12 in the direction indicated by the arrow, the inclined plane 27 of the joint 19 formed at the back of the tray 12 shields the laser light irradiated from the pickup unit 15. The laser light irradiated onto the inclined plane 27 of the joint 19 formed substantially parallel to the chassis 23 in the inclined position reenters the pickup unit 15 and when the control section detects a detection voltage of the laser light incident upon the pickup unit 15, the motor 20 starts driving and rotation.

In order to distinguish between the detection voltage corresponding to the laser light being irradiated from the pickup unit 15 onto the inclined plane 27 formed on the joint 19 and reentering the pickup unit 15 and the detection voltage corresponding to the laser light irradiating onto parts other than the inclined plane 27 and reentering the pickup unit 15, the control section determines a set value of the detection voltage which becomes a reference beforehand and when the detection voltage of the laser light detected by the control section indicates a higher value than with the set value, it is assumed that the laser light is shielded by the inclined plane 27.

The rotating/driving force of the motor 20 is transmitted to the rack gear 24 of the tray 12 through the drive transmission mechanism 21 and the tray 12 starts to move into the information recording and reproducing device 1 by the rotating/driving force of the motor 20 at this time.

That is, when the tray 12 is at a position between the disk loading/ejection position and the recording/reproducing position, laser light is irradiated from the pickup unit 15 and the laser light continues to irradiate the support part 13 of the frame 11 which makes up the recording and reproducing unit 10 until this laser light is shielded by the inclined plane 27 of the joint 19 formed in the tray 12, and therefore it is possible to distinguish whether the tray 12 is pushed by the user or not according to the difference between the detection voltage when the laser light reflected on the support part 13 enters the pickup unit 15 and the detection voltage when the laser light shielded by the inclined plane 27 of the joint 19 enters the pickup unit 15.

The detection voltage corresponding to the laser light being irradiated from the pickup unit 15 attached to the chassis 23 onto the inclined plane 27 of the joint 19 formed substantially parallel to the chassis 23 and reentering the pickup unit 15 is higher than the detection voltage corresponding to the laser light being reflected on the support section 13 formed in the upper part of the frame 11 of the recording and reproducing unit 10 and entering the pickup unit 15. This is attributable to the difference between the amount of laser light reflected on the inclined plane 27 and the amount of laser light reflected on parts other than the inclined plane 27 and the laser light reflected on parts other than the inclined plane 27 in particular is reflected diffusely and the amount of laser light incident upon the pickup unit 15 is reduced and the voltage value detected by the control section also decreases compared to the case where the laser light is reflected on the inclined plane 27. By the control section judging the difference in this voltage value based on the predetermined set value and starting/stopping the motor 20, it is possible to eliminate the switch conventionally used as the detection means.

When the tray 12 which moves driven by the driving force of the motor 20 reaches the recording/reproducing position inside the information recording and reproducing device 1, the chassis 23 mounted with the pickup unit 15 and the turntable 25 or the like starts to pivot on the joint with the frame 11 of the recording and reproducing unit 10 as a supporting point and the chassis 23 moves from the inclined position shown in FIG. 5(a) to the horizontal position shown in FIG. 5(b). At this time, as the chassis 23 moves to the horizontal position, the disk placed on the tray 12 is lifted slightly by the turntable 25 and the disk is held between the turntable 25 and damper 14. The disk held between the turntable 25 and damper 14 starts to turn according to the recording or playback operation by the user, the pickup unit 15 attached to the chassis 23 moves between the inner radius and outer radius of the disk along the guide members 22 perpendicular to the rotation direction of the disk and it is possible to record or reproduce information with the laser light irradiated from the pickup unit 15.

Here, by presetting a time after detecting that the inclined plane 27 formed in the joint 19 of the tray 12 on which the disk is placed is irradiated with the laser light from the pickup unit 15 until the recording/reproducing position of the disk is reached and controlling the motor 20 so that the motor 20 is rotated only for the set time after detecting that the inclined plane 27 is irradiated with the laser light and the rotation of the motor 20 is stopped when the set time passes, it is possible to stop the tray 12 carried in from the disk loading/ejection position outside the information recording and reproducing device 1 at the recording/reproducing position inside the information recording and reproducing device 1.

When starting the movement of the tray 12 at the disk loading/ejection position, if the user presses the opening and closing button which is one of the operation buttons 4 provided on the front panel 2 of the information recording and reproducing device 1 instead of pushing the front-end part at the tray 12, it is possible to stop the tray 12 carried in from the disk loading/ejection position outside the information recording and reproducing device 1 at the recording/reproducing position inside the information recording and reproducing device 1 by controlling the motor 20 so that it starts rotating/driving without detecting that the laser light from the pickup unit 15 is shielded by the inclined plane 27 of the joint 19 formed at the back of the tray 12, the motor 20 is rotated for only the set time after detecting that the inclined plane 27 is irradiated with the laser light from the pickup unit 15 and the laser light is shielded while the tray 12 is moving and the rotation of the motor 20 is stopped when the above set time passes.

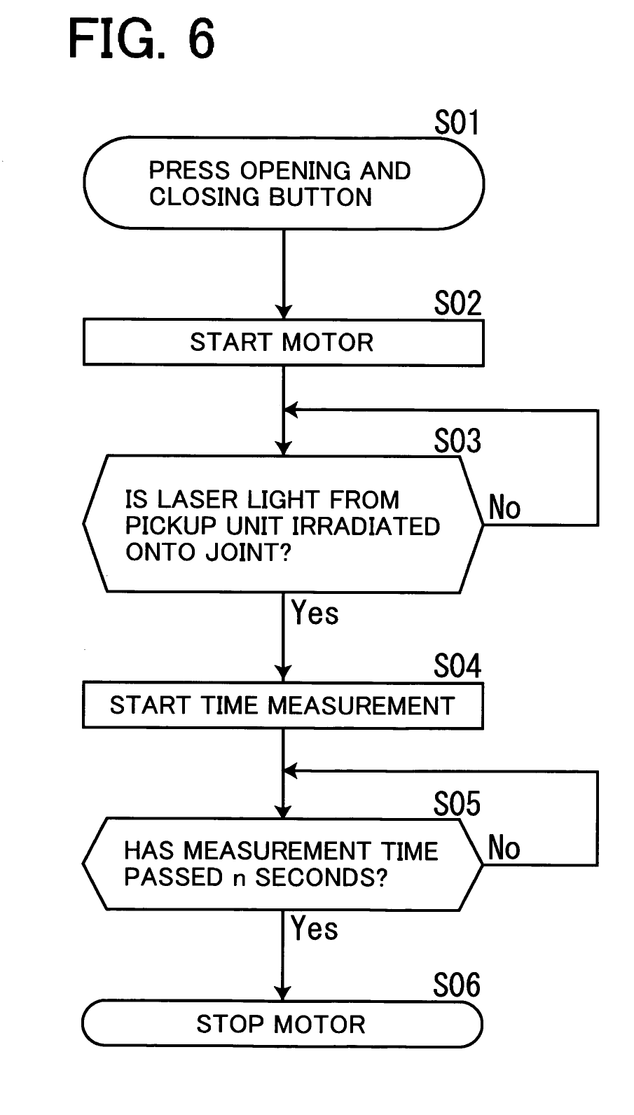

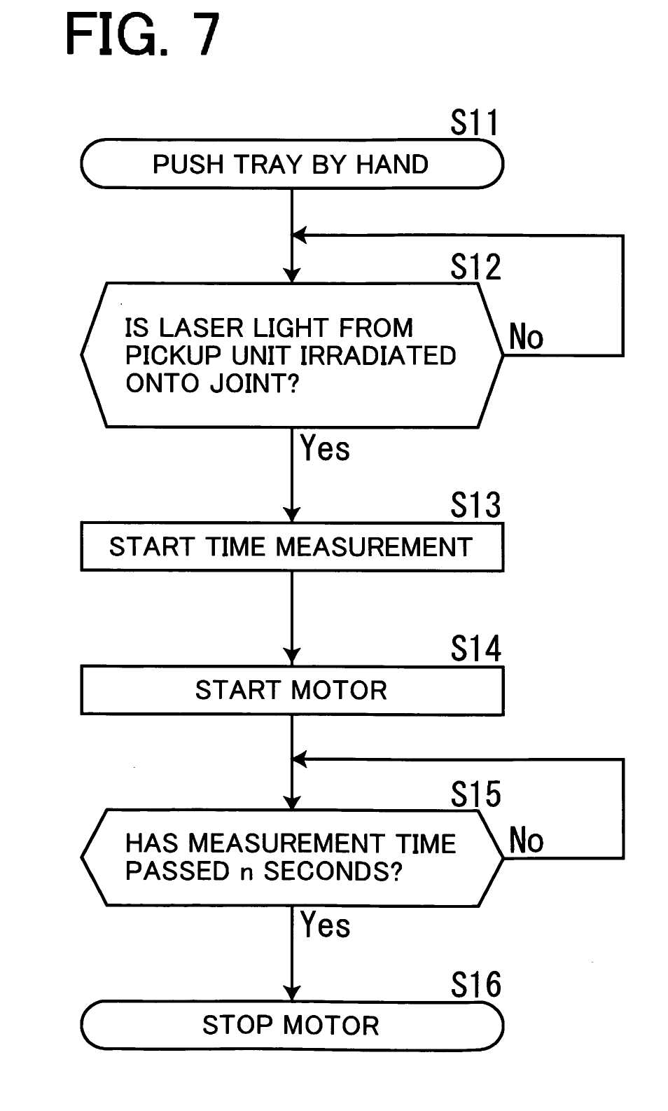

Here, the control processing until the tray 12 at the disk loading/ejection position reaches the recording/reproducing position inside the information recording and reproducing device 1 will be explained in detail using the flow charts shown in FIG. 6 and FIG. 7. FIG. 6 is a flow chart showing the control processing when moving the tray at the disk loading/ejection position outside the information recording and reproducing device to the recording/reproducing position inside the information recording and reproducing device by pressing the tray opening/closing button provided on the front panel of the information recording and reproducing device.

After the disk is placed on the tray 12 at the disk loading/ejection position outside the information recording and reproducing device 1, the motor 20 starts rotating/driving (step S01) when the user pushes the opening and closing button which is one of the operation buttons 4 which provided on the front panel 2 of the information recording and reproducing device 1 (step S02). The rotating/driving force of the motor 20 is transmitted to the rack gear 24 of the tray 12 through the drive transmission mechanism 21 and the tray 12 starts to move to the recording/reproducing position inside the information recording and reproducing device 1. When it is detected through a change of the voltage value that the laser light irradiated from the pickup unit 15 attached to the chassis 23 of the recording and reproducing unit 10 is irradiated onto the inclined plane 27 formed in the joint 19 of the tray 12 and shielded (step S03), measurement of the time after detecting that the inclined plane 27 is irradiated with the laser light is started (step S04). A time of n seconds after the laser light is irradiated onto the inclined plane 27 and shielded until the tray reaches the recording/reproducing position inside the information recording and reproducing device 1 is preset and control is performed so that when the measured time reaches n seconds (step S05), rotation/driving of the motor 20 is stopped (step S06).

FIG. 7 is a flow chart showing the control processing when moving the tray to the recording/reproducing position inside the information recording and reproducing device by the user's pushing the front-end part of the tray at the disk loading/ejection position outside the information recording and reproducing device 1 and starting the motor.

When the user presses the front-end part of the tray 12 in the direction shown by the arrow in FIG. 5(a) after placing the disk on the tray 12 at the disk loading/ejection position (step S11), it is detected from a change of the voltage value that the laser light irradiated from the pickup unit 15 attached to the chassis 23 of the recording and reproducing unit 10 is irradiated onto the inclined plane 27 formed in the joint 19 of the tray 12 (step S12) and measurement of the time after detecting that the inclined plane 27 is irradiated with the laser light is started (step S13) and the motor 20 starts rotating/driving (step S14). A time of n seconds after the laser light is irradiated onto the inclined plane 27 and shielded until the tray reaches the recording/reproducing position inside the information recording and reproducing device 1 is preset and control is performed so that when the measured time reaches n seconds (step S15), rotation/driving of the motor 20 is stopped (step S16).

After the tray 12 reaches the recording/reproducing position inside the information recording and reproducing device 1, recording of information onto the disk or reproduction of information recorded on the disk is performed through a common operation in both FIG. 6 and FIG. 7. That is, after the tray 12 reaches the recording/reproducing position inside the information recording and reproducing device 1, the chassis 23 in an inclined position starts to pivot on the joint with the frame 11 of the recording and reproducing unit 10 as a supporting point, the disk placed on the top surface of the tray 12 is slightly lifted from the tray 12 by the turntable 25 which is attached to the chassis 23, the disk is held between the turntable 25 and the damper 14 provided at a position facing the turntable 25, the disk held between the damper 14 and the turntable 25 is rotated and recording of information onto the disk or reproduction of information recorded on the disk is performed by the pickup unit 15.

Next, the operation when the tray 12 at the recording/reproducing position is moved to the disk loading/ejection position outside the information recording and reproducing device 1 will be explained.

As shown in FIG. 5(b), when the tray 12 is at the recording/reproducing position inside the information recording and reproducing device 1, the chassis 23 is in a horizontal position and the disk is held between the damper 14 and turntable 25. In this condition, laser light is not irradiated from the pickup unit 15 except when the user is performing the operation of recording information onto the disk or reproducing information recorded on the disk and laser light is irradiated from the pickup unit when the user pushes the opening and closing button which is one of the operation buttons 4 provided on the front panel 2 of the information recording and reproducing device 1. Substantially at the same time as laser light is irradiated from the pickup unit 15 by the user's pushing the opening and closing button, the chassis 23 including the pickup unit 15 and turntable 25 starts to pivot on the joint with the frame 11 of the recording and reproducing unit 10 as a supporting point and the chassis 23 starts to move from the horizontal position to the inclined position. At this time, the turntable 25 attached to the chassis 23 descends as the chassis 23 moves to the inclined position and the state in which the disk is held between the damper 14 and turntable 25 is canceled. When the chassis 23 further continues to pivot on the joint with the frame 11 of the recording and reproducing unit 10 as a supporting point, the disk which is lifted by the turntable 25 is placed on the top surface of the tray 12 and the chassis 23 is placed in an inclined position.

After the chassis 23 is placed in the inclined position, the motor 20 starts rotating/driving, the driving force is transmitted to the rack gear 24 of the tray 12 through the drive transmission mechanism 21 and the tray 12 at the recording/reproducing position inside the information recording and reproducing device 1 starts to move to the disk loading/ejection position outside the information recording and reproducing device 1. The time after it is detected that the inclined plane 27 formed by the joint 19 of the tray 12 is irradiated with the laser light from the pickup unit 15 and the laser light is shielded until the tray reaches the disk loading/ejection position outside the information recording and reproducing device 1 is preset and control is performed so that the motor 20 is rotated only for the set time after detecting that inclined plane 27 is irradiated with the laser light and the laser light is shielded and the rotation of the motor 20 is stopped when the set time passes, and it is possible to thereby stop the tray 12 carried from the recording/reproducing position inside the information recording and reproducing device 1 at the disk loading/ejection position outside the information recording and reproducing device 1.

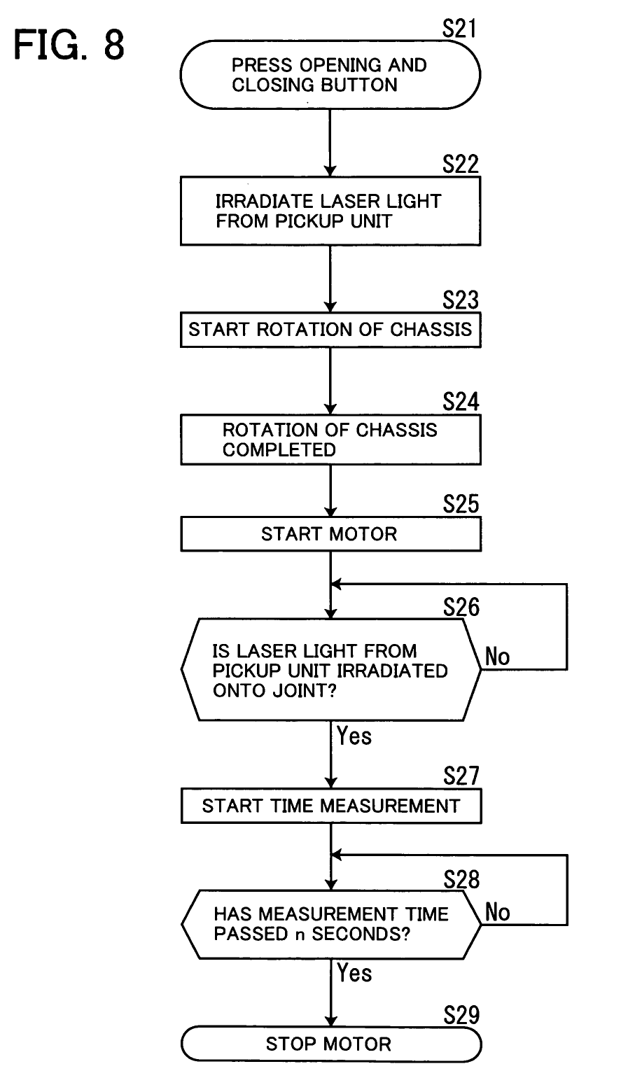

Here, the control processing until the tray 12 at the recording/reproducing position reaches the disk loading/ejection position outside the information recording and reproducing device 1 will be explained in detail using the flowchart shown in FIG. 8. FIG. 8 is the flowchart showing the control processing when the tray at the recording/reproducing position inside the information recording and reproducing device is moved to the disk loading/ejection position outside the information recording and reproducing device by pressing the opening and closing button of the tray provided on the front panel of the information recording and reproducing device.

At the recording/reproducing position inside the information recording and reproducing device 1, the disk turns held between the clamper 14 and turntable 25 and after recording of information onto the disk or reproducing of information recorded on the disk by the pickup unit 15 which moves perpendicular to the rotation direction of the disk is completed, the rotation of the turntable 25 stops and the laser light is not irradiated from the pickup unit 15. By the user's pressing the opening and closing button which is one of the operation buttons 4 provided on the front panel 2 of the information recording and reproducing device 1 in this condition (step S21), laser light is irradiated from pickup unit 15 (step S22) and the chassis 23 starts to pivot from the horizontal position to the inclined position on the joint with the frame 11 of the recording and reproducing unit as a supporting point (step S23).

In the process of the chassis 23 pivoting from the horizontal position to the inclined position, the state of the disk being held between the damper 14 and turntable 25 is canceled and the disk lifted by the turntable 25 is placed on the top surface of the tray 12 as the chassis 23 pivots. When the inclined position of chassis 23 is completed (step S24), the motor 20 starts rotating/driving (step S25) and the tray 12 starts to move from the recording/reproducing position inside the information recording and reproducing device 1 to the disk loading/ejection position outside the information recording and reproducing device 1 through the drive transmission mechanism 21. When it is detected from a change of the voltage value that the laser light irradiated from the pickup unit 15 attached to the chassis 23 of the recording and reproducing unit 10 is irradiated onto the inclined plane 27 formed in the joint 19 of the tray 12 and shielded (step S26), measurement of the time after detecting that the inclined plane 27 is irradiated with the laser light is started (step S27). A time of n seconds after the laser light is irradiated onto the inclined plane 27 and shielded until the tray reaches the disk loading/ejection position outside the information recording and reproducing device 1 is preset and control is performed so that when the measured time reaches n seconds (step S28), rotation/driving of the motor 20 is stopped (step S29) There is no problem even if the order of step S22 and step S23 is reversed.

The embodiment of the present invention has been explained in detail so far, but the present invention is not limited to the embodiment and can be implemented modified in various ways within the range not departing from the essence of the present invention. For example, the embodiment has described the case where the motor for moving the tray between the disk loading/ejection position outside the information recording and reproducing device and the recording/reproducing position inside the information recording and reproducing device is provided apart from the drive source for pivoting the chassis mounted with the turntable and the pickup unit or the like, but the present invention is not limited to this and the movement of the tray and pivoting of the chassis can also be performed by a single drive source. Furthermore, this embodiment has described the contents that an inclined plane is provided in the joint of the tray and the inclined plane is irradiated with laser light irradiated from the pickup unit for detection, but the present invention is not limited to this and various ways can be selected as appropriate, for example, laser light is detected with a reflector attached to the joint of the tray or a plurality of uneven planes are provided for the joint.

Moreover, this embodiment has described the contents that the motor is driven after detecting the laser light irradiated from the pickup unit until the preset time of n seconds passes when the disk loading/ejection position or the recording/reproducing position is reached and the motor is stopped when the set time of n seconds passes, but the present invention is not limited to this and there can also be a case where a time after a time to be preset is detected by the pickup unit until a time at which the disk loading/ejection position or the recording/reproducing position passes is set.

The effects of the present invention are as follows.

The recording and reproducing unit according to the first aspect of the present invention is a recording and reproducing unit comprising a tray on which a storage medium is placed, a frame which supports the tray such that the tray can freely make a reciprocating motion, a pickup unit built in the frame which writes information onto the storage medium or reads information from the storage medium and drive means for moving the tray from the outside of the frame where the storage medium can be changed to the inside of the frame where the storage medium faces the pickup unit, wherein the position of the storage medium on the tray is detected by using laser light irradiated from the pickup unit to detect whether the storage medium is transferred to a recording/reproducing position facing the pickup unit or not or whether the storage medium is transferred to a disk loading/ejection position outside the frame or not and wherein the drive means is controlled based on a detection signal of the pickup unit, and therefore the laser light irradiated from the pickup unit also serves as tray position detection means and it is possible to eliminate the conventionally required tray position detection switch, reduce the number of parts and the number of man-hours in assembly work leading to a cost reduction and downsizing of the unit through the elimination of the space in which the switch is mounted in the frame of the recording and reproducing unit.

The information recording and reproducing device incorporating a recording and reproducing unit according to the second aspect of the present invention is an information recording and reproducing device incorporating a recording and reproducing unit and control means for controlling the drive means of the recording and reproducing unit, the recording and reproducing unit comprising a tray on which a storage medium is placed drive means for driving the tray, and a pickup unit which writes information onto the storage medium or reads information from the storage medium, wherein the drive means is controlled through the control means based on a detection signal from the pickup unit by using laser light irradiated from the pickup unit to detect whether the storage medium is transferred to a recording/reproducing position facing the pickup unit or not or whether the storage medium is transferred to a disk loading/ejection position outside the frame or not, and therefore it is detected using laser light irradiated from the pickup unit whether the tray is transferred to the disk loading/ejection position outside the information recording and reproducing device or to the recording/reproducing position inside the information recording and reproducing device and it is possible to eliminate the conventionally required tray position detection switch, reduce the number of parts and the number of man-hours in assembly work leading to a cost reduction and downsizing of the unit through the elimination of the space in which the switch is mounted in the frame of the recording and reproducing unit.

The information recording and reproducing device incorporating a recording and reproducing unit according to the third aspect of the present invention is the information recording and reproducing device which incorporates a recording and reproducing unit according to the second aspect of the present invention, wherein upon detecting by means of laser light irradiated from the pickup unit that the tray has been manually pushed from the disk loading/ejection position where the storage medium can be changed to the inside of the information recording and reproducing device, the drive means is controlled through the control means based on a detection signal by the laser light, and therefore it is possible to eliminate the conventionally required tray position detection switch to detect that the tray has been moved by the user's pushing the front-end part of the tray at the disk loading/ejection position, reduce the number of parts and the number of man-hours in assembly work leading to a cost reduction and downsizing of the unit through the elimination of the space in which the switch is mounted in the frame of the recording and reproducing unit.

The information recording and reproducing device incorporating a recording and reproducing unit according to the fourth aspect of the present invention is the information recording and reproducing device which incorporates a recording and reproducing unit according to the second or third aspect of the present invention, wherein the tray is provided with an opening for allowing laser light irradiated from the pickup unit to impinge on the recording surface of the storage medium and a joint behind the opening and wherein the tray drive means is controlled in response to detecting that the joint is irradiated with the laser light irradiated from the pickup unit, and therefore it is possible to eliminate the conventionally required tray position detection switch as means for detecting the position of the tray, reduce the number of parts and the number of man-hours in assembly work leading to a cost reduction and downsizing of the unit through the elimination of the space in which the switch is mounted in the frame of the recording and reproducing unit.

The information recording and reproducing device incorporating a recording and reproducing unit according to the fifth aspect of the present invention is the information recording and reproducing device which incorporates a recording and reproducing unit according to any one of the second to fourth aspects of the present invention, wherein the position of the moving tray is detected from a change in the voltage value when the laser light irradiated from the pickup unit is reflected and the reflected laser light is received by the pickup unit, and therefore it is possible to accurately detect the position of the tray which moves to the disk loading/ejection position or recording/reproducing position.

The information recording and reproducing device incorporating a recording and reproducing unit according to the sixth aspect of the present invention is the information recording and reproducing device which incorporates a recording and reproducing unit according to the fourth or fifth aspect of the present invention, wherein the joint of the tray is provided with an inclined plane as the plane facing the pickup unit, and therefore it is possible to clarify the difference between a case where laser light from the pickup unit is irradiated onto the inclined plane formed on the joint of the moving tray and reflected and a case where laser light is irradiated onto parts other than the inclined plane and reflected and thereby accurately detect the position of the tray.

The information recording and reproducing device incorporating a recording and reproducing unit according to the seventh aspect of the present invention is the information recording and reproducing device which incorporates a recording and reproducing unit according to any one of the fourth to sixth aspects of the present invention, wherein the laser light irradiated from the pickup unit reflected on the joint of the tray is detected, and the drive means is controlled by presetting the time for the tray to reach the disk loading/ejection position from inside the information recording and reproducing device or the time for the tray to reach the recording/reproducing position from outside the information recording and reproducing device, and therefore it is possible to stop the moving tray at the disk loading/ejection position or the recording/reproducing position without using the conventionally required tray position detection switch as the means for detecting the position of the tray.

The information recording and reproducing device incorporating a recording and reproducing unit according to the eighth aspect of the present invention is the information recording and reproducing device which incorporates a recording and reproducing unit according to any one of the second to seventh aspects of the present invention, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position, and therefore it is possible to more accurately detect that laser light irradiated from the pickup unit is irradiated onto the inclined plane formed on the joint of the moving tray and thereby control the driving or stoppage of the moving tray.

1. A recording and reproducing unit comprising:
a tray on which a storage medium is placed;
a frame which supports the tray such that the tray can freely make a reciprocating motion;
a pickup unit built in the frame which writes information onto the storage medium or reads information from the storage medium; and
drive means for moving the tray from the outside of the frame where the storage medium can be changed to the inside of the frame where the storage medium faces the pickup unit,
wherein the position of the storage medium on the tray is detected by using laser light irradiated from the pickup unit to detect whether the storage medium is transferred to a recording/reproducing position facing the pickup unit or not or whether the storage medium is transferred to a disk loading/ejection position outside the frame or not and wherein the drive means is controlled based on a detection signal of the pickup unit.

2. An information recording and reproducing device incorporating a recording and reproducing unit and control means for controlling the drive means of the recording and reproducing unit, the recording and reproducing unit comprising:
a tray on which a storage medium is placed;
drive means for driving the tray; and
a pickup unit which writes information onto the storage medium or reads information from the storage medium,
wherein the drive means is controlled through the control means based on a detection signal from the pickup unit by using laser light irradiated from the pickup unit to detect whether the storage medium is transferred to a recording/reproducing position facing the pickup unit or not or whether the storage medium is transferred to a disk loading/ejection position outside the frame or not.

3. The information recording and reproducing device which incorporates a recording and reproducing unit according to claim 2, wherein upon detecting by means of laser light irradiated from the pickup unit that the tray has been manually pushed from the disk loading/ejection position where the storage medium can be changed to the inside of the information recording and reproducing device, the drive means is controlled through the control means based on a detection signal by the laser light.

4. The information recording and reproducing device which incorporates a recording and reproducing unit according to claim 2, wherein the tray is provided with an opening for allowing laser light irradiated from the pickup unit to impinge on the recording surface of the storage medium and a joint behind the opening and wherein the tray drive means is controlled in response to detecting that the joint is irradiated with the laser light irradiated from the pickup unit.

5. The information recording and reproducing device which incorporates a recording and reproducing unit according to claim 2, wherein the position of the moving tray is detected from a change in the voltage value when the laser light irradiated from the pickup unit is reflected and the reflected laser light is received by the pickup unit.

6. The information recording and reproducing device which incorporates a recording and reproducing unit according to claim 4, wherein the joint of the tray is provided with an inclined plane as the plane facing the pickup unit.

7. The information recording and reproducing device which incorporates a recording and reproducing unit according to claim 4, wherein the laser light irradiated from the pickup unit reflected on the joint of the tray is detected, and the drive means is controlled by presetting the time for the tray to reach the disk loading/ejection position from inside the information recording and reproducing device or the time for the tray to reach the recording/reproducing position from outside the information recording and reproducing device.

8. The information recording and reproducing device which incorporates a recording and reproducing unit according to claim 2, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position.

9. The information recording and reproducing device which incorporates a recording and reproducing unit according to claim 3, wherein the tray is provided with an opening for allowing laser light irradiated from the pickup unit to impinge on the recording surface of the storage medium and a joint behind the opening and wherein the tray drive means is controlled in response to detecting that the joint is irradiated with the laser light irradiated from the pickup unit.

10. The information recording and reproducing device which incorporates a recording and reproducing unit according to claim 3 wherein the position of the moving tray is detected from a change in the voltage value when the laser light irradiated from the pickup unit is reflected and the reflected laser light is received by the pickup unit.

11. The information recording and reproducing device which incorporates a recording and reproducing unit according to claim 4, wherein the position of the moving tray is detected from a change in the voltage value when the laser light irradiated from the pickup unit is reflected and the reflected laser light is received by the pickup unit.

12. The information recording and reproducing device which incorporates a recording and reproducing unit according to claim 5 , wherein the joint of the tray is provided with an inclined plane as the plane facing the pickup unit.

13. The information recording and reproducing device which incorporates a recording and reproducing unit according to claim 5, wherein the laser light irradiated from the pickup unit reflected on the joint of the tray is detected, and the drive means is controlled by presetting the time for the tray to reach the disk loading/ejection position from inside the information recording and reproducing device or the time for the tray to reach the recording/reproducing position from outside the information recording and reproducing device.

14. The information recording and reproducing device which incorporates a recording and reproducing unit according to claim 6, wherein the laser light irradiated from the pickup unit reflected on the joint of the tray is detected, and the drive means is controlled by presetting the time for the tray to reach the disk loading/ejection position from inside the information recording and reproducing device or the time for the tray to reach the recording/reproducing position from outside the information recording and reproducing device.

15. The information recording and reproducing device which incorporates a recording and reproducing unit according to claim 3, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position.

16. The information recording and reproducing device which incorporates a recording and reproducing unit according to claim 4, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position.

17. The information recording and reproducing device which incorporates a recording and reproducing unit according to claim 5, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position.

18. The information recording and reproducing device which incorporates a recording and reproducing unit according to claim 6, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position.

19. The information recording and reproducing device which incorporates a recording and reproducing unit according to claim 7, wherein the tray is enabled to make a reciprocating motion between the disk loading/ejection position and the recording/reproducing position by transmitting the rotating/driving force of the motor which is drive means to the tray through a drive transmission mechanism using a combination of gear groups and a pulley, the pickup unit is attached to the chassis through guide members to support the pickup unit in a slidable manner, one end of the chassis is connected inside the frame of the recording and reproducing unit, the chassis pivots on the one end at which the chassis is connected to the frame as a supporting point and the tray at the disk loading/ejection position is thereby placed in an inclined position and the tray at the recording/reproducing position is placed in a horizontal position, and the inclined plane formed on the joint of the tray is formed so as to become substantially parallel to an angle when the chassis is in the inclined position.
